(19) United States
(12) Patent Application Publication
(10) Pub. No.: US 2018/0352057 A1
(43) Pub. Date: Dec. 6, 2018

(54) Application-Level Mechanism for Multi-Path Transport

(71) Applicant: Smartiply, Inc., Basking Ridge, NJ (US)

(72) Inventor: Shunge Li, Duluth, GA (US)

(21) Appl. No.: 15/993,575

(22) Filed: May 30, 2018

Related U.S. Application Data
(60) Provisional application No. 62/515,518, filed on Jun. 5, 2017.

(51) Int. Cl. H04L 29/06; H04L 12/26; H04L 12/863; H04L 12/861

(52) U.S. Cl. CPC H04L 69/14; H04L 43/08; H04L 69/16; H04L 49/90; H04L 47/50

(57) ABSTRACT

This disclosure describes an application-level multi-path transport protocol (MPTP) mechanism for establishing a plurality of communication paths between a sender device and a receiver device to transmit and receive data packets. The mechanism at the sender end includes a plurality of send connectors each being a sender endpoint of a communication path, a path table that maintains characteristics of the bi-directional communication paths, a scheduler that determines a suitable send connector over which to transmit each data packet, and a send buffer that buffers the data packets prior to transmission. The mechanism at the receiver end includes a plurality of receive connectors each being a receiver endpoint of a communication path, a path table that maintains characteristics of the bi-directional communication paths, a receive buffer that buffers the data packets received by the receive connectors, and an assembler that reassembles the plurality of data packets in the receive buffer.

### RELATED APPLICATIONS

This patent applications claims the benefit of U.S. Provisional Patent Application Ser. No. 62/515,518 filed on Jun. 5, 2017.

### FIELD

The present disclosure relates to computer networking and particularly to application-level multi-path transport mechanism.

### BACKGROUND

Today's Internet is full of various types of hosts (e.g. smartphones, PCs, routers, data center servers) equipped with multiple wireless and/or wired network interfaces, making it possible to establish multiple communication paths between two communication endpoints. However, a vast majority of Internet applications is based on TCP (Transport Control Protocol) and UDP (User Datagram Protocol). Designed several decades ago, TCP and UDP applications perform data transport over a single communication path between two endpoints for a given session. In recent years, there has been an effort to extend the regular TCP protocol to use multiple paths for data transport, giving rise to a new IETF standard called Multi-Path TCP (MPTCP) that is an extension of the TCP protocol. Despite being the most promising effort to date for a new mechanism to provide multi-path data transport, the adoption of MPTCP has been painfully slow, largely because it requires support not only from the operating systems on both endpoints, but also from the middleboxes along all the multiple paths between the endpoints. Therefore, developing an application-level multi-path transport mechanism, which not only does not require upgrades of the operating systems at both communication endpoints but also is middlebox-friendly, has become valuable. The present disclosure shows such a mechanism that is easy to deploy where regular TCP or UDP applications are supported.

### BRIEF DESCRIPTION OF THE DRAWINGS

FIG. 1 is a simplified block diagram of an exemplary embodiment of client/server applications communicating using Multi-Path Transport Protocol (MPTP) APIs (Application Programming Interfaces) according to the teachings of the present disclosure;

FIG. 2 is a simplified block diagram of an exemplary embodiment of a software architecture for Multi-Path Transport Protocol (MPTP) send and receive APIs according to the teachings of the present disclosure;

FIGS. 3A and 3B are simplified diagrams illustrating direct and indirect paths of an exemplary embodiment of Multi-Path Transport Protocol (MPTP) according to the teachings of the present disclosure; and

FIG. 4 is a simplified diagram illustrating Multi-Path Transport Protocol (MPTP) client and server modeling according to the teachings of the present disclosure.

### DETAILED DESCRIPTION

The current wave of the Internet of Things (IoT) technology calls for many physical devices and objects to be communicatively connected. However, the internet infrastructure has limited resources and faces many challenges in keeping up with growing demands for connectivity. On the other hand, the concept of shared economy is gaining ground because it allows limited resources to be better allocated to people or “things” that need them. Network interfaces are such a type of resources that can be leveraged to provide robust connectivity and boosted bandwidth, which are required by mission critical commercial and consumer applications (e.g. drone delivery, healthcare, media and entertainment) to stay connected all the time or to provide a better user experience.

Many internet applications are designed to use only one network interface for connectivity, thus not taking advantage of all of the available network interfaces that reside on the devices. Those applications that do utilize multiple network interfaces equipped on a device rely on mechanisms that have limitations: (1) some of them rely on MPTCP (Multi-Path Transport Control Protocol), which requires support from the underlying operating system and support in all of the middleboxes along the path; (2) some of them rely on mechanisms such as Virtual Private Network (VPN) or proxy, which either are prohibited by some organizations or countries due to security concerns, or incur additional performance overheads; and (3) some of them map a data session to a given path only in its entirety, contrary to inverse multiplexing, which gives rise to the ability for a data session to ride across multiple paths. As the ability to support inverse multiplexing is key to achieve improved throughput/bandwidth, enhanced load-balancing and reliability, robust connectivity, etc., it has become a major challenge to determine how to leverage multiple equipped network interfaces simultaneously without requiring a rigorous deployment option or other security- or policy-prohibitive techniques.

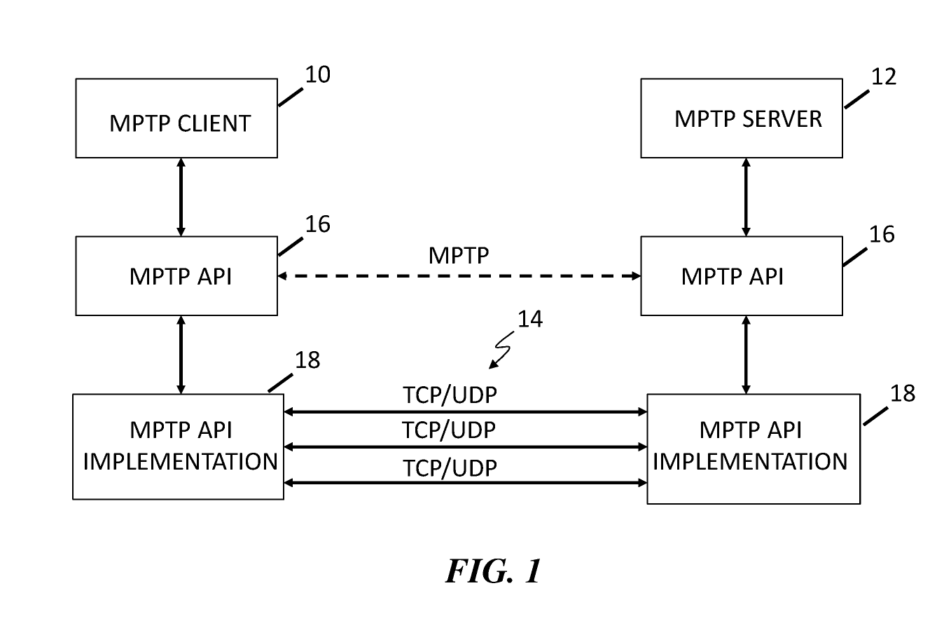

The present disclosure describes an application-level mechanism for multi-path data transport to circumvent the deployment challenges facing MPTCP (RFC 6824) while offering more flexibility and functionalities than MPTCP. FIG. 1 is a simplified block diagram of an exemplary embodiment of client/server applications communicating using Multi-Path Transport Protocol (MPTP) APIs (Application Programming Interfaces) according to the teachings of the present disclosure. At the core of this new mechanism is an application-level MPTP, which enables an MPTP-client 10 and an MPTP-server 12 to send and/or receive data using multiple bi-directional communications paths 14 between the two endpoints. Because MPTP is implemented on top of regular TCP and/or UDP without root permissions or operating system upgrade at either endpoint, MPTP can be easily deployed on any host running a modern operating system such as Unix, Linux, Android, iOS, Windows, Blackberry O.S., etc. Furthermore, MPTP has the same treatment as regular TCP and/UDP when it comes to policies at intermediate endpoints—it does not require these devices to be aware of MPTP for its paths to pass through them. Moreover, MPTP does not rely on Virtual Private Network (VPN) tunneling or proxying, hence it does not inherit the security concerns associated with VPN. Furthermore, the MPTP mechanism provides applications with multiple configuration options or policies to optimize data transmission in terms of reliability, latency, throughput, and redundancy. Lastly, the MPTP mechanism is language-agnostic and can be ported to any platform supporting C, C++, Java, Python, etc. Therefore, the MPTP mechanism is far more flexible than all prior mechanisms in this space, including the MPTCP.

The MPTP functions are exposed as a set of APIs (Application Programming Interfaces) 16 that can be packaged as a library for distribution. Developers can use these APIs to write MPTP-compliant applications. These APIs 16 are used in the same way other APIs are used to take advantage of MPTP functions. Since MPTP can be implemented in any programming language, it can be made available on, or easily portable to, any platform without needing any operating system upgrade or incurring middlebox complications. Cross-platform interoperability is inherently supported.

Referring to FIG. 1, an MPTP client/server application 10 and 12 uses MPTP

APIs 16 to implement the multi-path transport service. MPTP functions are exposed to the upper layer in the form of MPTP APIs 16. MPTP APIs 16 hide all the multi-path transport implementation details from the application. MPTP is implemented on top of TCP or UDP. This choice is closely related to the policy set by the application based on the goal it wants to achieve. Supported policies include boosting throughput and bandwidth, maximizing reliability, guaranteeing in-sequence delivery, maintaining connectivity (i.e., failover capability), maximizing data security, and hybrid policies. The MPTP APIs 16 let applications specify “what” they want to do and the API implementation 18 handles “how” to do it. The MPTP APIs 16 perform the functions of path management (create a path, destroy a path, join a connection, leave a connection, etc.), connection management (create a connection and teardown a connection), data transmission (send data and receive data), and miscellaneous APIs (set policy).

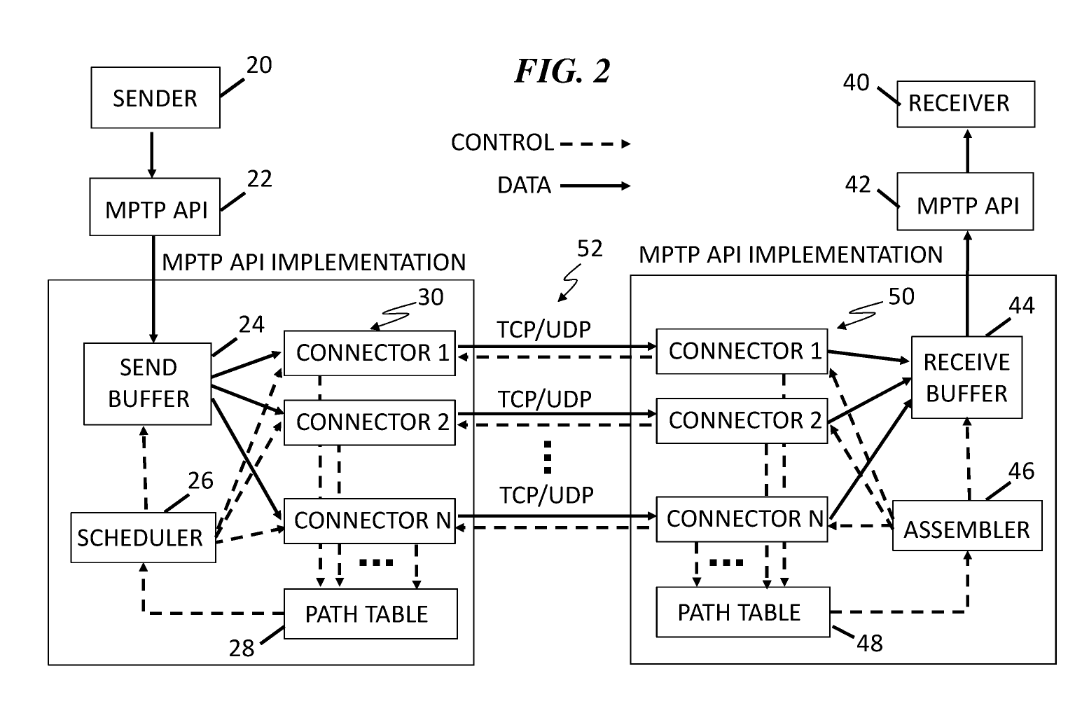

FIG. 2 depicts an exemplary software architecture of an MPTP API implementation. The sender 20 includes an MPTP API 22 that includes a send buffer 24, a scheduler 26, a path table 28, and a plurality of connectors 30. On the receiver side 40, the MPTP API 42 includes a receive buffer 44, an assembler 46, a path table 48, and a plurality of connectors 50. At least one communication path 52 between the sender 20 and the receiver 40 must be established before the sender 20 can send data to the receiver 40. There is a connector 30 and 50 at either side of a communication path 52 responsible for transmitting data packets. The send buffer 24 temporarily stores the data prior to transmission by the connector 30. The scheduler's job is to determine one or more suitable paths (or connectors) over which to transmit the next data packet. The scheduling algorithm can be influenced by the policy that is in effect at the time as well as each path's characteristics, including throughput, latency, loss rate, congestion window, etc. On the receiver side 40, the connectors 50 receive the data packets which are then temporarily stored by the receive buffer 44. The assembler 46 is responsible for putting the received data packets back together in the correct sequence, and also serves as a feedback loop so the scheduler 26 can determine if or how to execute retransmission strategy. The path tables 28 and 48 maintain each path's characteristics monitored and measured periodically in real time. Policy is set by the application based on the goal it wants to achieve: maximizing throughput, maximizing reliability, guaranteeing in-sequence delivery, maintaining connectivity (ability to failover), etc.

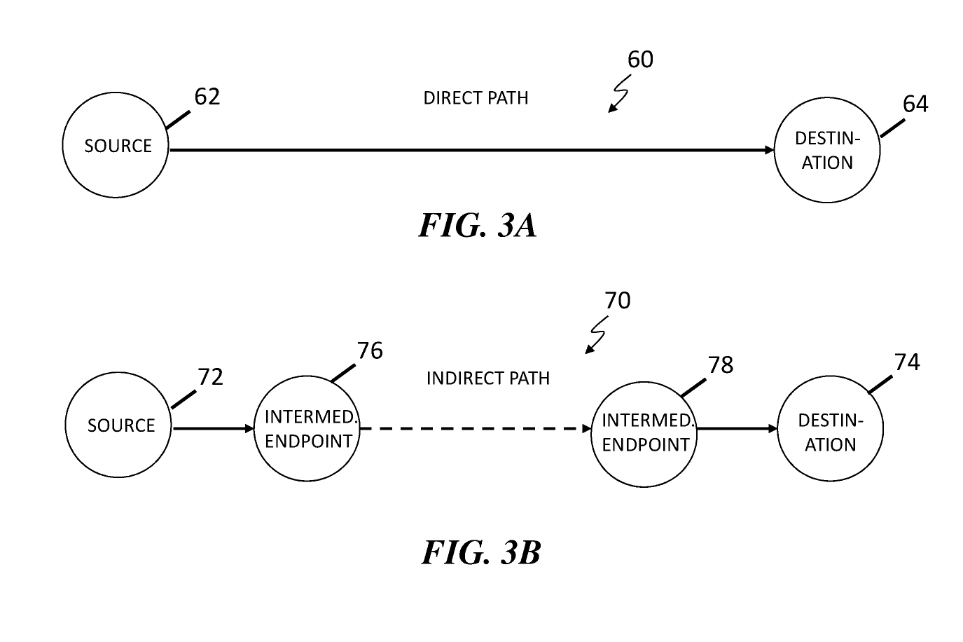

A communication path can be direct or indirect in terms of Layer 4 connectivity, as shown in FIGS. 3A and 3B. A direct path 60 is established between a source 62 and a destination 64, and is characterized by a 5-tuple (source host IP address, source host port number, destination host IP address, destination host port number, communication protocol). An indirect path 70 is established between a source 72 and a destination 74, and is characterized by one or more intermediate endpoints 76 and 78, in addition to the source and destination endpoints 72 and 74, with each intermediate endpoint 76 and 78 specified by its IP address and port number, as well as the protocols (TCP or UDP) it uses for communication with its adjacent endpoints along the path. An example of an indirect path is tethering where the source endpoint relies completely on an intermediate endpoint for (internet) connectivity with the destination endpoint. The intermediate endpoints 76 and 78 along an indirect path must be MPTP-aware and must be transparent in relaying MPTP traffic between source 72 and destination 74.

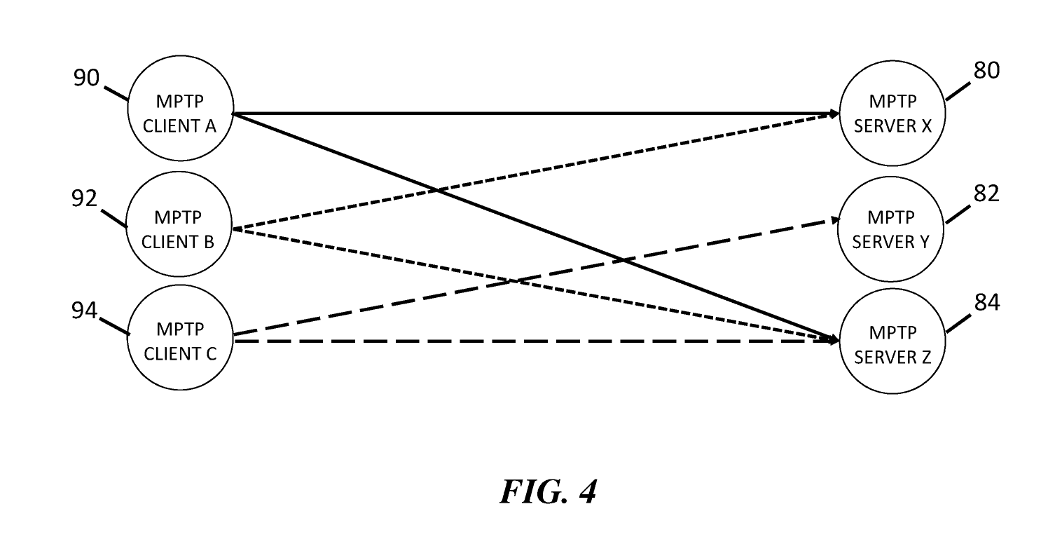

As shown in FIG. 4, each MPTP server 80-84 is able to support multiple concurrent MPTP clients 90-94. Likewise, an MPTP client 90-94 is able to simultaneously interact with multiple MPTP servers 80-84. Therefore, proper data structures are created inside an MPTP client and an MPTP server to manage various MPTP connections as well as path objects. An MPTP server maintains an internal registry (or connection manager) so it can quickly locate the connection object for a given client. A similar table is also maintained on the client side. Additionally, an application can associate a user-friendly name with a path or a connection and the application can access path and connection objects by name. Applicable devices/hosts include smartphones, tablets, laptop PCs, internet routers and gateways, data center servers, etc. Network interfaces include cellular (GSM, CDMA, LTE), Wi-Fi (Wi-Fi AP and Wi-Fi Direct), Bluetooth, Zigbee, wired LAN and WAN (ethernet, DSL, Cable, fiber), etc.

It should be noted that a peer-to-peer application can use MPTP API in a way that each peer acts as both an MPTP client and an MPTP server.

Potential applications for MPTP include:

Mobile or desktop applications that provide boosted bandwidths using multiple network connections enabled by its own equipped network interfaces or by wirelessly connected nearby devices.

Gateway or router products that support cellular (GSM, CDMA, LTE), wireless (Wi-Fi, Wi-Fi Direct, Bluetooth, Zigbee, Z-Wave), and wireline (DSL, Cable, Fiber, Ethernet) connections.

Finer-grained load-balancer (software and hardware based).

Applications running on data center servers (including virtual machines) that support reliability, redundancy, fault-tolerance, and failover capabilities.

Device-to-Device (D2D) based fog computing and resource sharing.

Bandwidth hungry applications such as live streaming video, video surveillance, Augmented Reality and Virtual Reality (ARVR), etc.

Transaction-oriented data transmission.

The features of the present invention which are believed to be novel are set forth below with particularity in the appended claims. However, modifications, variations, and changes to the exemplary embodiments described above will be apparent to those skilled in the art, and the Application-Level Multi-Path Transport Protocol (MPTP) mechanism described herein thus encompasses such modifications, variations, and changes and are not limited to the specific embodiments described herein.

What is claimed is:

1. A multi-path transport protocol (MPTP) API for establishing a plurality of bi-directional communication paths between a sender device and a receiver device to transmit and receive a plurality of data packets, comprising:
a send MPTP API for the sender device including:
a plurality of send connectors each being a sender endpoint of a communication path established between the sender device and the receiver device;
a path table configured to maintain characteristics of the plurality of communication paths;
a scheduler configured to determine a suitable send connector to transmit each data packet using one of the plurality of communication paths between the sender device and the receiver device; and
a send buffer configured to buffer the plurality of data packets prior to transmitting each data packet to the selected send connector; and
a receive MPTP API for the receiver device including:
a plurality of receive connectors each being a receiver endpoint of a communication path established between the sender device and the receiver device;
a path table configured to maintain characteristics of the plurality of bi-directional communication paths;
a receive buffer configured to buffer the plurality of data packets received by the receive connectors; and
an assembler configured to reassemble the plurality of data packets in the receive buffer.

2. The MPTP API as set forth in claim 1, wherein the path table stores characters of each communication path's throughput, latency, loss rate, and congestion window.

3. The MPTP API as set forth in claim 1, wherein the assembler further provides feedback on a communication path to the scheduler.

4. The MPTP API as set forth in claim 1, wherein the scheduler is configured to transmit each data packet over a plurality of communication paths each consisting of at least one intermediate node.

5. The MPTP API as set forth in claim 1, wherein the scheduler is configured to transmit each data packet over a plurality of communication paths each consisting of zero to a plurality of intermediate nodes.

6. The MPTP API as set forth in claim 1, wherein the plurality of send and receive connectors are configured to support establishing communication paths using Transport Control Protocol.

7. The MPTP API as set forth in claim 1, wherein the plurality of send and receive connectors are configured to support establishing communication paths using User Datagram Protocol.

8. A method for establishing a plurality of bi-directional communication paths between a sender device and a receiver device to transmit and receive a plurality of data packets, comprising:
providing a send MPTP API in the sender device having:
a plurality of send connectors each being a sender endpoint of a communication path established between the sender device and the receiver device;
a path table configured to maintain characteristics of the plurality of communication paths;
a scheduler configured to determine a suitable send connector to transmit each data packet using one of the plurality of communication paths between the sender device and the receiver device; and
a send buffer configured to buffer the plurality of data packets prior to transmitting each data packet to the selected send connector; and
providing a receive MPTP API in the receiver device having:
a plurality of receive connectors each being a receiver endpoint of a communication path established between the sender device and the receiver device;
a path table configured to maintain characteristics of the plurality of bi-directional communication paths;
a receive buffer configured to buffer the plurality of data packets received by the receive connectors; and
an assembler configured to reassemble the plurality of data packets in the receive buffer.

9. The method as set forth in claim 8, wherein the path table stores characters of each communication path's throughput, latency, loss rate, and congestion window.

10. The method as set forth in claim 8, wherein the assembler further provides feedback on a communication path to the scheduler.

11. The method as set forth in claim 8, wherein the scheduler transmits each data packet over a plurality of communication paths each consisting of at least one intermediate node.

12. The method as set forth in claim 8, wherein the scheduler transmits each data packet over a plurality of communication paths each consisting of zero to a plurality of intermediate nodes.

13. The method as set forth in claim 8, wherein the plurality of send and receive connectors establish communication paths using Transport Control Protocol.

14. The method as set forth in claim 8, wherein the plurality of send and receive connectors establish communication paths using User Datagram Protocol.

15. A multi-path transport protocol (MPTP) API for establishing a plurality of bi-directional communication paths between two end points to transmit and receive a plurality of data packets, comprising:
a plurality of connectors each being a network interface for a communication path established between the two end points;
a path table configured to maintain characteristics of the plurality of communication paths;
a scheduler configured to determine a suitable connector to transmit each data packet using one of the plurality of communication paths between the two end points;
a buffer configured to buffer the plurality of data packets prior to transmission or receiving to or from the connectors; and
an assembler configured to reassemble the plurality of data packets received from the connectors and stored in the buffer.

16. The MPTP API as set forth in claim 15, wherein the scheduler is configured to transmit each data packet over a plurality of communication paths each consisting of zero to a plurality of intermediate nodes.

17. The MPTP API as set forth in claim 15, wherein the plurality of send and receive connectors are configured to support establishing communication paths using Transport Control Protocol/User Datagram Protocol.
